(19) United States
(12) Patent Application Publication
(10) Pub. No.: US 2010/0297396 A1
(43) Pub. Date: Nov. 25, 2010

(54) WORKPIECE WITH POSITIONAL MARKER AND METHOD FOR MACHINING THE POSITIONAL MARKER

(75) Inventor: SEI-PING LOUH, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Taipei Hsien (TW)

(21) Appl. No.: 12/612,063

(22) Filed: Nov. 4, 2009

(30) Foreign Application Priority Data
May 23, 2009 (CN) 200910302550.8

(51) Int. Cl. B32B 3/30; B23Q 11/00

(52) U.S. Cl. 428/156; 409/131

(57) ABSTRACT

A workpiece includes a positional marker and defines a number of round recesses. The positional marker includes first positional projection, at least one second positional projection, and at least one third positional projection. The first positional projection defines a first diagonal and a second diagonal. The second positional projection is arranged along the first diagonal, and has a diagonal on the first diagonal. The third positional projection is arranged along the second diagonal, and has a diagonal on the second diagonal. Each of the first positional projection, the at least one second positional projection, and the at least one third positional projection is surrounded by four round recesses of the number of round recesses.

### BACKGROUND

1. Technical Field

The present disclosure relates to positional markers and, particularly, to a workpiece with a positional marker and a method for machining the positional marker.

2. Description of Related Art

A typical positional marker of a workpiece is consisted of two line-shaped protrusions or recesses, which are perpendicular to each other. In order to machine the positional marker easily by a machine tool, a large width of the line-shaped protrusion is desired. However, if the line-shaped protrusions or recesses are too big, the precision of the positional marker will be decrease.

What is needed, therefore, is a workpiece with a positional marker with high precision to overcome or at least mitigate the above-described problem.

### BRIEF DESCRIPTION OF THE DRAWINGS

Many aspects of the present workpiece with a positional marker and method for machining the positional marker can be better understood with reference to the accompanying drawings. The components in the drawings are not necessarily drawn to scale, the emphasis instead being placed upon clearly illustrating the principle of the present workpiece with a positional marker and method for machining the positional marker. In the drawings, all the views are schematic.

FIG. 1 is a plan view of a workpiece with a positional marker according to an exemplary embodiment.

FIG. 2 is a cross sectional view of the workpiece taken along line II-II of FIG. 1.

### DETAILED DESCRIPTION

Embodiments of the present disclosure will now be described in detail below, with reference to the accompanying drawings.

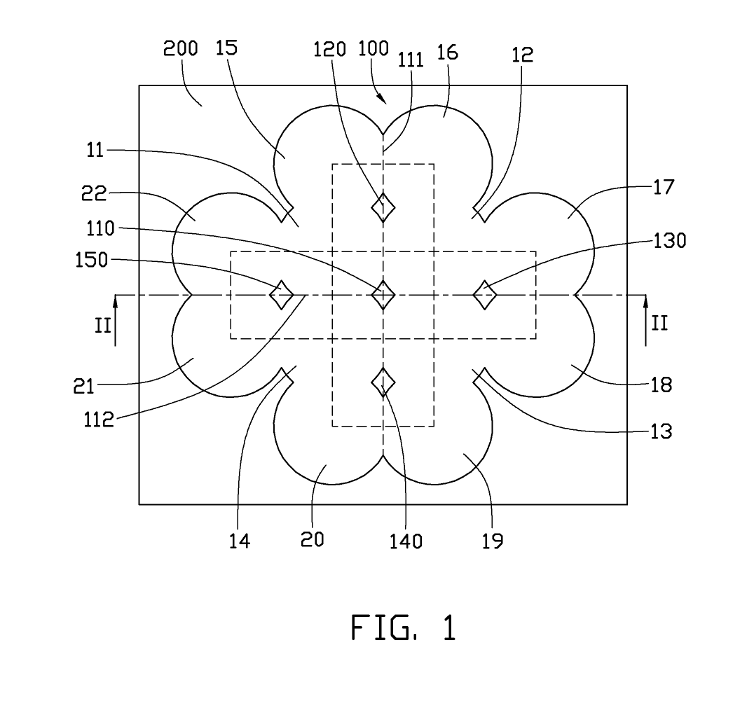

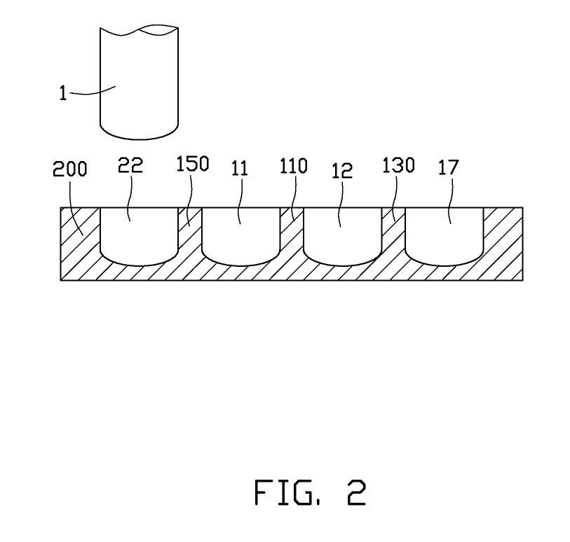

Referring to FIGS. 1 and 2, a workpiece 200 according to an exemplary embodiment, is shown. The workpiece 200 defines a number of round recesses thereon. In the present embodiment, the workpiece 200 defines twelve round recesses 11, 12, 13, 14, 15, 16, 17, 18, 19, 20, 21, and 22.

The round recesses 11, 12, 13, and 14 surround a first positional projection 110. The round recesses 11, 12, 15, and 16 surround a second positional projection 120. The round recesses 12, 13, 17, and 18 surround a third positional projection 130. The round recesses 13, 14, 19, and 20 surround a fourth positional projection 140. The round recesses 11, 14, 21, and 22 surround a fifth positional projection 150. The first positional projection 110, the second positional projection 120, the third positional projection 130, the fourth positional projection 140, and the fifth positional projection 150 cooperatively form a positional marker 100.

The first positional projection 110 defines a first diagonal 111 and a second diagonal 112. The second positional projection 120 and the fourth positional projection 140 are arranged along the first diagonal 111, and each has a diagonal on the first diagonal 111. The third positional projection 130 and the fifth positional projection 150 are arranged along the second diagonal 112, and each has a diagonal on the second diagonal 111.

In the present embodiment, the round recesses 11, 12, 13, 14, 15, 16, 17, 18, 19, 20, 21, and 22 have a same diameter. The centers of the round recesses 11, 12, 13, and 14 surrounding the first positional projection 110 are arranged on a rectangle. The distance between the centers of the two adjacent round recesses 11 and 12 is smaller than the sum of the semidiameters of the round recesses 11 and 12. The distance between the centers of the two diagonal round recesses 11 and 13 is bigger than the sum of the semidiameters of the round recesses 11 and 13. Thus, the first positional projection 110 can be formed among the four round recesses 11, 12, 13, and 14.

The relationship among the four round recesses 11, 12, 15, and 16 surrounding the second positional projection 120, the relationship among the four round recesses 12, 13, 17, and 18 surrounding a third positional projection 130, the relationship among the four round recesses 13, 14, 19, and 20 surrounding a fourth positional projection 140, and the relationship among the four round recesses 11, 14, 21, and 22 surrounding a fifth positional projection 150 are similar to that of the four round recesses 11, 12, 13, and 14.

The number of the positional projections of the positional marker 100 is not limited to five, the number of the positional projections of the positional marker 100 can also be three, four, six, etc. For example, the positional marker 100 can only includes the first positional projection 110, the second positional projection 120, and the third positional projection 130.

The positional marker 100 can be machined on the workpiece 200 by cutting twelve round recesses 11, 12, 13, 14, 15, 16, 17, 18, 19, 20, 21, and 22 on a surface of the workpiece 200. In the present embodiment, the twelve round recesses 11, 12, 13, 14, 15, 16, 17, 18, 19, 20, 21, and 22 can be cut by a rotating cutter 1. The rotating cutter 1 can be a rotating cutter of a milling machine.

In the present embodiment, each of the positional projections is surrounded by four round recesses, each positional projection has a tip end with relative smaller width. Therefore, the precision of the positional marker 100 is enhanced.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. A workpiece comprising a positional marker and defining a plurality of round recesses, the positional marker comprising:
a first positional projection defining a first diagonal and a second diagonal;
at least one second positional projection, the second positional projection being arranged along the first diagonal, and having a diagonal on the first diagonal; and
at least one third positional projection, the third positional projection being arranged along the second diagonal, and having a diagonal on the second diagonal,
wherein, each of the first positional projection, the at least one second positional projection, and the at least one third positional projection is surrounded by four round recesses of the plurality of round recesses.

2. The workpiece of claim 1, wherein the at least one second positional projection comprises two second positional projections located at two opposite sides of the first positional projection.

3. The workpiece of claim 1, wherein the at least one third positional projection comprises two third positional projections located at two opposite sides of the first positional projection.

4. The workpiece of claim 1, wherein the plurality of round recesses have a same diameter.

5. The workpiece of claim 4, wherein the centers of the four round recesses surrounding one of the first positional projection, the at least one second positional projection, and the at least one third positional projection are arranged on a rectangle.

6. The workpiece of claim 5, wherein the distance between the centers of two adjacent round recesses of the four round recesses is smaller than the sum of the semidiameters of the two adjacent round recesses, and the distance between the centers of two diagonal round recesses of the four round recesses is bigger than the sum of the semidiameters of the two diagonal round recesses.

7. A method for machining a positional marker on a workpiece comprising:
cutting a plurality of round recesses in a surface of the workpiece,
wherein, four round recesses of the plurality of round recesses surround a first positional projection defining a first diagonal and a second diagonal; four round recesses of the plurality of round recesses surround a second positional projection, the second positional projection is arranged along the first diagonal, and having a diagonal on the first diagonal; and four round recesses of the plurality of round recesses surround a third positional projection, the third positional projection is arranged along the second diagonal, and having a diagonal on the second diagonal.

8. The method of claim 7, wherein the plurality of round recesses have a same diameter.

9. The method of claim 8, wherein the centers of the four round recesses surrounding one of the first positional projection, the second positional projection, and the third positional projection are arranged on a rectangle.

10. The method of claim 9, wherein the distance between the centers of two adjacent round recesses of the four round recesses is smaller than the sum of the semidiameters of the two adjacent round recesses, and the distance between the centers of two diagonal round recesses of the four round recesses is bigger than the sum of the semidiameters of the two diagonal round recesses.

11. The method of claim 7, wherein the plurality of round recesses are cut by a rotating cutter of a milling machine.

12. A workpiece comprising a surface and a plurality of round recesses defined in the surface, the round recesses arranged in columns and rows, the round recesses overlapping one another, the round recesses equidistantly spaced from each other, every four adjacent round recesses surrounding a protrusion.
